(19) United States
(12) Patent Application Publication
(10) Pub. No.: US 2020/0211736 A1
(43) Pub. Date: Jul. 2, 2020

(54) WIRE HARNESS

(71) Applicant: SUMITOMO WIRING SYSTEMS, LTD., Yokkaichi-shi, Mie (JP)

(72) Inventor: Masashi HAYASHI, Yokkaichi, Mie (JP)

(73) Assignee: SUMITOMO WIRING SYSTEMS, LTD., Yokkaichi-shi, Mie (JP)

(21) Appl. No.: 16/479,768

(22) PCT Filed: Jan. 17, 2018
(86) PCT No.: PCT/JP2018/001203

§ 371 Date: Jul. 22, 2019

(30) Foreign Application Priority Data
Jan. 25, 2017 (JP) 2017-011301

(51) Int. Cl. H01B 7/42; H01B 7/00

(52) U.S. Cl. CPC H01B 7/423; H01B 7/0045

(57) ABSTRACT

A wire harness that includes a harness that includes an electric wire, a protective tube through which the electric wire is passed, and a first external tube that has a tubular shape and is brought into intimate contact with and fixed to an outer surface of an end of the protective tube; a heat dissipation member that includes an air tube and a second external tube that has a tubular shape and is brought into intimate contact with and fixed to an outer surface of a first end of the air tube; and a first communication tube that brings an inner portion of the first external tube and an inner portion of the second external tube into communication with each other.

This application is the U.S. National Phase of PCT/JP2018/001203 filed Jan. 17, 2018, which claims priority to JP 2017-011301 filed Jan. 25, 2017, the entire disclosure of which is incorporated herein by reference.

### BACKGROUND

The present disclosure relates to a wire harness.

Conventionally, vehicles such as electric automobiles and hybrid vehicles include a wire harness that electrically connects, for example, a battery and an inverter. The wire harness is routed, for example, under the floor of the vehicle or the like. The wire harness includes a plurality of electric wires and a pipe that covers the plurality of electric wires. A waterproof cover is attached to an end portion of the pipe. The wire harness routed under the vehicle floor has a hermetically sealed structure, and a ventilation member is attached to the wire harness so as to suppress deformation caused by changes in the internal pressure associated with changes in temperature (see, for example, JP 2013-241143A).

### SUMMARY

In the wire harness described above, heat emitted from the electric wires when energized and changes in ambient temperature affect the members included in the wire harness. For example, due to the heat emitted from the energized electric wires and changes in ambient temperature, the internal pressure of the wire harness changes. Due to changes in the internal pressure, for example, the waterproof cover made of rubber or the like repeatedly expands and contracts. If the waterproof cover expands and interferes with a peripheral member, damage or the like may occur.

An exemplary aspect of the disclosure provides a wire harness that enables improved heat dissipation.

A wire harness according to the present disclosure includes: a harness that includes an electric wire, a protective tube through which the electric wire is passed, and a first external tube that has a tubular shape and is brought into intimate contact with and fixed to an outer surface of an end of the protective tube; a heat dissipation member that includes an air tube and a second external tube that has a tubular shape and is brought into intimate contact with and fixed to an outer surface of a first end of the air tube; and a first communication tube that brings an inner portion of the first external tube and an inner portion of the second external tube into communication with each other.

With this configuration, the heat emitted from the electric wire when energized is transferred to the second external tube that is in communication with the first external tube through the first communication tube. That is, the heat in the harness is transferred to the heat dissipation member. In the heat dissipation member, a flow of air flowing from the outside toward a second end of the air tube is created. In this way, ambient air enters the second external tube, passes through the air tube, and is discharged from the second end of the air tube. Accordingly, heat is unlikely to stay in the harness, and thus the heat dissipation properties of the harness are improved.

The harness may be one of a plurality of harnesses included in the wire harness. In this case, the wire harness preferably includes a second communication tube that brings the inner portions of the first external tubes of two harnesses out of the plurality of harnesses into communication with each other.

With this configuration, heat is unlikely to stay in each of the plurality of harnesses, and thus the heat dissipation properties of the harnesses are improved.

The wire harness described above preferably has a ventilation that is connected to the second external tube, and allows the passage of a gas therethrough, but restricts the passage of a liquid.

With this configuration, it is possible to prevent a liquid and the like from entering the harnesses.

In the wire harness described above, it is preferable that the first external tube, the second external tube, and the first communication tube are integrally formed.

With this configuration, the first external tube and the second external tube can be easily brought into communication with each other. Also, the number of components can be reduced.

With the wire harness according to the present disclosure, heat dissipation properties can be improved.

### BRIEF DESCRIPTION OF THE DRAWINGS

FIG. 1 is a schematic view of a wire harness.

FIG. 2 is a schematic cross-sectional view showing an inner portion of a cover member.

### DETAILED DESCRIPTION OF EMBODIMENTS

Hereinafter, an embodiment will be described.

In the accompanying drawings, constituent elements may be shown enlarged for the purpose of ease of understanding. Accordingly, the scaling factor of the constituent elements may be different from the actual size, and the scaling factor of the constituent elements may vary from diagram to diagram. Also, in the cross-sectional view, hatching may be omitted in a portion of the constituent elements for the purpose of ease of understanding.

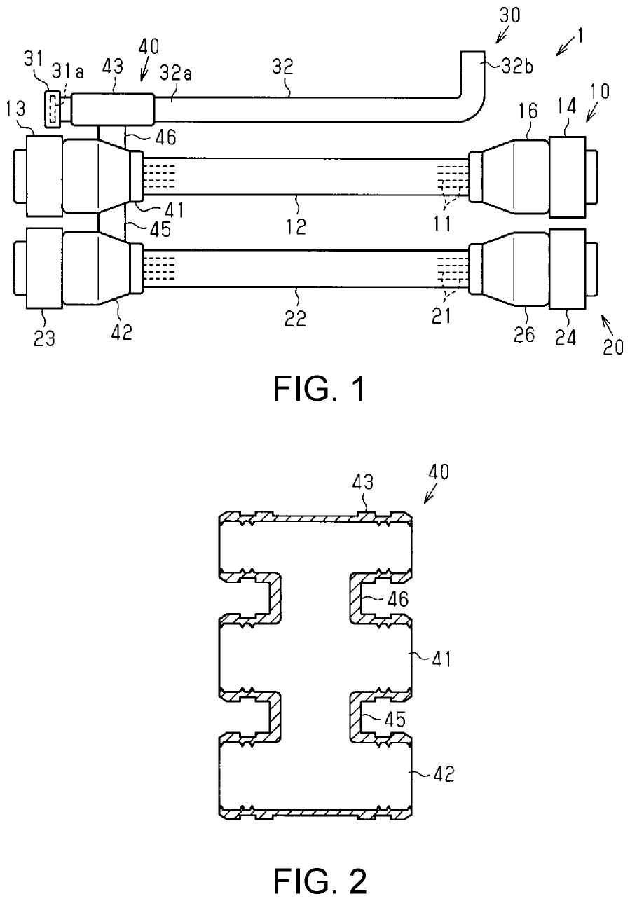

A wire harness 1 shown in FIG. 1 is routed, for example, in a vehicle such as a hybrid vehicle. The wire harness 1 electrically connects various electric devices installed on the vehicle to each other.

The wire harness 1 includes: a plurality of (two in FIG. 1) harness members 10 and 20 (harnesses); and a heat dissipation member 30.

In the present embodiment, the harness members 10 and 20 and the heat dissipation member 30 are connected to each other by a cover member 40. The cover member 40 includes: external members 41 and 42 (external tubes) for the harness members 10 and 20; an external member 43 for the heat dissipation member 30; a connection member 45 that connects the external members 41 and 42; and a connection member 46 that connects the external members 41 and 43. That is, the harness members 10 and 20 and the heat dissipation member 30 are connected to each other via the external members 41, 42, and 43 of the harness members 10 and 20 and the heat dissipation member 30 and the connection members 45 and 46.

The harness member 10 includes: a plurality of (for example, three) electric wires 11; a protective tube 12 through which the electric wires 11 are passed; connectors 13 and 14 that are connected to the electric wires 11; and external members 41 and 16 that cover the connectors 13 and 14, respectively. The protective tube 12 protects the electric wires 11 from water droplets, flying stones, and the like. As the protective tube 12, for example, a metal pipe made of aluminum or the like, a flexible corrugated tube made of a resin or any other material, or the like can be used.

The external member 41 has a substantially tubular shape. The external member 41 is provided spanning the connector 13 (which is a connector shell or a housing) and the protective tube 12. The external member 41 is fixedly fastened to the outer side of the connector 13 and the outer side of the protective tube 12 by a fixing band (not shown). The external member 41 is in hermetic contact with the outer side of the connector 13 and the outer side of the protective tube 12. As the material of the external member 41, for example, rubber, an elastomer, or the like can be used.

The external member 16 has a substantially tubular shape. The external member 16 is provided spanning the connector 14 (which is a connector shell or a housing) and the protective tube 12. The external member 16 is fixedly fastened to the outer side of the connector 14 and the outer side of the protective tube 12 by a fixing band (not shown). The external member 16 is in hermetic contact with the outer side of the connector 14 and the outer side of the protective tube 12. As the material of the external member 16, for example, rubber, an elastomer, or the like can be used.

The harness member 20 includes: a plurality of (for example, three) electric wires 21; a protective tube 22 through which the electric wires 21 are passed; connectors 23 and 24 that are connected to the electric wires 21; and external members 42 and 26 that cover the connectors 23 and 24, respectively. The protective tube 22 protects the electric wires from water droplets, flying stones, and the like. As the protective tube 22, for example, a metal pipe made of aluminum or the like, a flexible corrugated tube made of a resin or any other material, or the like can be used.

The external member 42 has a substantially tubular shape. The external member 42 is provided spanning the connector 23 (which is a connector shell or a housing) and the protective tube 22. The external member 42 is fixedly fastened to the outer side of the connector 23 and the outer side of the protective tube 22 by a fixing band (not shown). The external member 42 is in hermetic contact with the outer side of the connector 23 and the outer side of the protective tube 22. As the material of the external member 42, for example, rubber, an elastomer, or the like can be used.

The external member 26 has a substantially tubular shape. The external member 26 is provided spanning the connector 24 and the protective tube 22. The external member 26 is fixedly fastened to the outer side of the connector 24 and the outer side of the protective tube 22 by a fixing band (not shown). The external member 26 is in hermetic contact with the outer side of the connector 24 and the outer side of the protective tube 22. As the material of the external member 26, for example, rubber, an elastomer, or the like can be used.

The heat dissipation member 30 includes the external member 43, and a ventilation member 31 and an air tube 32 that are attached to the external member 43. The external member 43 has a substantially tubular shape. The ventilation member 31 is attached to one end portion of the external member 43, and a first end portion 32a of the air tube 32 is attached to the other end portion of the external member 43. The first end portion 32a of the air tube 32 is open. The inner portion of the air tube 32 is in communication with the inner portion of the external member 43. A second end portion 32b of the air tube 32 is open.

In the present embodiment, the major portion of the air tube 32 extends along the protective tube 12. However, the air tube 32 is provided such that the second end portion 32b is provided at a position higher than the position at which the first end portion 32a, or in other words, the external member 43 is provided. For example, the air tube 32 is bent such that the second end portion 32b extends upward. The second end portion 32b of the air tube 32 is provided in an area that water droplets and the like cannot reach such as, for example, in a vehicle cabin.

The ventilation member 31 includes a ventilation film 31a. The ventilation film 31a is a rectangular thin film that has a predetermined thickness. The ventilation film 31a has the property of allowing the passage of a gas therethrough but restricting the passage of a liquid. In the present embodiment, the ventilation member 31 allows the passage of a gas from the outside of the external member 43 to the inner portion of the external member 43 through the ventilation film 31a, but restricts the passage of a liquid. As the ventilation film 31a, for example, a porous body made of a fluorocarbon resin such as polytetrafluoroethylene (PTFE) can be used. Also, as the ventilation film 31a, any other porous body, woven fabric, non-woven fabric, a net, foam, or the like may be used.

As the material of the external member 43, for example, rubber, an elastomer, or the like can be used. As the material of the air tube 32, for example, a metal pipe made of aluminum or the like, a flexible corrugated tube made of a resin or any other material, or the like can be used.

FIG. 2 is a cross-sectional view schematically showing the inner portion of the cover member 40.

The connection member 45 is provided between the external member 41 of the harness member 10 and the external member 42 of the harness member 20 so as to connect the external members 41 and 42 to each other. The connection member 45 has a tubular shape, and brings the inner portion of the external member 41 and the inner portion of the external member 42 into communication with each other. That is, the connection member 45 functions as a second communication member (second communication tube) that brings the inner portion of the external member 41 and the inner portion of the external member 42 into communication with each other.

The connection member 46 is provided between the external member 41 of the harness member 10 and the external member 43 of the heat dissipation member 30 so as to connect the external members 41 and 43 to each other. The connection member 46 has a tubular shape, and brings the inner portion of the external member 41 and the inner portion of the external member 43 into communication with each other. That is, the connection member 46 functions as a first communication member (first communication tube) that brings the inner portion of the external member 41 and the inner portion of the external member 43 into communication with each other.

(Actions)

The inner portion of the air tube 32 of the heat dissipation member 30 is in communication with the inner portion of the external member 43. The external member 43 is connected to the external member 41 of the harness member 10 via the connection member 46. The connection member 46 brings the inner portion of the external member 43 of the heat dissipation member 30 and the inner portion of the external member 41 of the harness member 10 into communication with each other. Accordingly, the air tube 32 is in communication with the protective tube 12 of the harness member 10 via the external member 43, the connection member 46, and the external member 41.

In the harness member 10, the air in the harness member 10 is heated by the heat emitted from the electric wires 11 when energized, and thus the internal temperature increases. The inner portion of the harness member 10 is in communication with the inner portion of the heat dissipation member 30 via the connection member 46. Accordingly, the heat in the harness member 10 is transferred to the inner portion of the heat dissipation member 30. The heat dissipation member 30 includes the ventilation member 31 and the air tube 32 that are attached to the external member 43. In the heat dissipation member 30, a flow of air flowing from the ventilation member 31 toward the second end portion 32b of the air tube 32 is created. In this way, the ambient air enters the ventilation member 31, passes through the air tube 32, and is discharged from the second end portion 32b. Accordingly, heat is unlikely to stay in the harness member 10, and thus the heat dissipation properties of the harness member 10 are improved.

As a result of the heat dissipation properties of the harness member 10 being improved, deformation of the external members 41 and 16 of the harness member 10 is suppressed. Accordingly, the external members 41 and 16 are unlikely to interfere with a peripheral member. Also, because deformation of the external members 41 and 16 is suppressed, functional degradation of the external members 41 and 16 is suppressed.

The external member 42 of the harness member 20 is connected to the external member 41 of the harness member 10 via the connection member 45. The connection member 45 brings the inner portion of the external member 41 of the harness member 10 and the inner portion of the external member 42 of the harness member 20 into communication with each other. The air tube 32 of the heat dissipation member 30 is in communication with the protective tube 22 of the harness member 20 via the external member 43, the connection member 46, the external member 41, the connection member 45, and the external member 42. Accordingly, in the harness member 20 as well, as with the harness member 10, heat is unlikely to stay in the harness member 20, and thus the heat dissipation properties of the harness member 20 are improved.

As a result of the heat dissipation properties of the harness member 20 being improved, deformation of the external members 42 and 26 of the harness member 20 is suppressed. Accordingly, the external members 42 and 26 are unlikely to interfere with a peripheral member. Also, because deformation of the external members 42 and 26 is suppressed, functional degradation of the external members 42 and 26 is suppressed.

Also, the wire harness 1 includes one ventilation member 31 for to two harness members 10 and 20. That is, the ventilation member 31 allows a gas to pass through the two harness members 10 and 20, but restricts the passage of a liquid therethrough. Accordingly, it is unnecessary to provide ventilation members individually to the harness members 10 and 20, and thus an increase in the cost of the wire harness 1 can be suppressed.

The ventilation member 31 includes the ventilation film 31a. The ventilation film 31a has the property of allowing the passage of a gas therethrough but restricting the passage of a liquid. In the present embodiment, the ventilation member 31 allows the passage of a gas from the outside of the external member 43 to the inner portion of the external member 43 through the ventilation film 31a, but restricts the passage of a liquid. Accordingly, with the ventilation member 31, it is possible to prevent a liquid and the like from entering the harness members 10 and 20.

The cover member 40 is a single component, and includes external members 41, 42, and 43, and connection members 45 and 46. The external members 41, 42, and 43 and the connection members 45 and 46 are integrally formed, or in other words, inseparably formed. For this reason, the external members 41, 42, and 43 can be easily brought into communication with each other. Also, the number of components of the wire harness 1 can be reduced, and thus a cost reduction can be achieved.

As described above, according to the present embodiment, the following advantageous effects can be obtained.

(1) A wire harness 1 includes two harness members 10 and 20 and one heat dissipation member 30. The harness member 10 includes: a protective tube 12 through which an electric wire 11 is passed; connectors 13 and 14 that are connected to the electric wire 11; and external members 41 and 16 that partially cover the connectors 13 and 14, respectively. The harness member 20 includes: a protective tube 22 through which an electric wire 21 is passed; connectors 23 and 24 that are connected to the electric wire 21; and external members 42 and 26 that partially cover the connectors 23 and 24, respectively.

The heat dissipation member 30 includes: an air tube 32; an external member 43 that is fixed to the outer surface of a first end portion 32a of the air tube 32; and a ventilation member 31 that is attached to the external member 43. The external member 43 of the heat dissipation member 30 is connected to the external member 41 of the harness member 10 via a connection member 46. The connection member 46 brings the inner portion of the external member 43 of the heat dissipation member 30 and the inner portion of the external member 41 of the harness member 10 into communication with each other. Accordingly, the air tube 32 of the heat dissipation member 30 is in communication with the protective tube 12 of the harness member 10 via the external member 43, the connection member 46, and the external member 41.

The heat emitted from the electric wire 11 when energized is transferred to the external member 43 that is in communication with the external member 41 via the connection member 46. That is, the air in the harness member 10 is transferred to the heat dissipation member 30. In the heat dissipation member 30, a flow of air flowing from the outside toward a second end portion 32b of the air tube 32 is created. In this way, ambient air enters the external member 43, passes through the air tube 32, and is discharged from the second end portion 32b. Accordingly, heat is unlikely to stay in the harness member 10, and thus the heat dissipation properties of the harness member 10 can be improved.

(2) The external member 42 of the harness member 20 is connected to the external member 41 of the harness member 10 via a connection member 45. The connection member 45 brings the inner portion of the external member 41 of the harness member 10 and the inner portion of the external member 42 of the harness member 20 into communication with each other. The air tube 32 of the heat dissipation member 30 is in communication with the protective tube 22 of the harness member 20 via the external member 43, the connection member 46, the external member 41, the connection member 45, and the external member 42. Accordingly, in the harness member 20 as well, as with the harness member 10, heat is unlikely to stay in the plurality of harness members 10 and 20, and thus the heat dissipation properties of the harness members 10 and 20 can be improved.

(3) The wire harness 1 includes one ventilation member 31 for two harness members 10 and 20. That is, the ventilation member 31 allows a gas to pass through the two harness members 10 and 20, but restricts the passage of a liquid therethrough. Accordingly, it is unnecessary to provide ventilation members individually to the harness members 10 and 20, and thus an increase in the cost of the wire harness 1 can be suppressed.

(4) The ventilation member 31 includes a ventilation film 31a. The ventilation film 31a has the property of allowing the passage of a gas therethrough but restricting the passage of a liquid. In the present embodiment, the ventilation member 31 allows the passage of a gas from the outside of the external member 43 to the inner portion of the external member 43 through the ventilation film 31a, but restricts the passage of a liquid. Accordingly, with the ventilation member 31, it is possible to prevent a liquid and the like from entering the harness members 10 and 20.

(5) The external members 41, 42, and 43 and the connection members 45 and 46 of the cover member 40 are integrally formed, or in other words, formed inseparable from each other. For this reason, the external members 41, 42, and 43 can be easily brought into communication with each other. Also, the number of components of the wire harness 1 can be reduced, and thus a reduction in cost can be achieved.

The embodiment described above may be carried out in the following manner.

In the embodiment described above, the ventilation member 31 is attached to the external member 43 of the heat dissipation member 30. This is done so as to prevent water droplets and the like from entering because at a position at which the external member 43, or in other words, the connectors 13 and 23 of the harness members 10 and 20 are provided, water droplets or the like can reach the external member 43. Accordingly, in the case of a wire harness in which the connectors 13 and 23 are provided in an area that water droplets and the like cannot reach, the ventilation member 31 may be omitted.

The wire harness 1 according to the embodiment described above includes two harness members 10 and 20, but the wire harness may include one harness member, or three or more harness members.

In the embodiment described above, the ventilation member 31 may be attached to the second end portion 32b of the air tube 32. By attaching the ventilation member 31 as described above, it is possible to further prevent water droplets and the like from entering the harness members. It is also possible to increase the degree of freedom in the position at which the second end portion 32b of the air tube 32 can be provided.

In the embodiment described above, the protective tubes 12 and 22 may be protective tubes that have a structure in which, for example, electroconductive shield layers are stacked on or embedded in the main body of a non-metal pipe (a resin pipe or the like).

It should be understood that those skilled in the art will clearly understand that the present disclosure may be embodied in other specific forms without departing from the technical concept of the present disclosure. For example, a portion of the components described in the embodiment (or one or a plurality of aspects thereof) may be omitted, or some of the components may be combined.

1. A wire harness comprising:
a harness that includes an electric wire, a protective tube through which the electric wire is passed, and a first external tube that has a tubular shape and is brought into intimate contact with and fixed to an outer surface of an end of the protective tube;
a heat dissipation member that includes an air tube and a second external tube that has a tubular shape and is brought into intimate contact with and fixed to an outer surface of a first end of the air tube; and
a first communication member that brings an inner portion of the first external tube and an inner portion of the second external tube into communication with each other.

2. The wire harness according to claim 1, wherein:
the harness is one of a plurality of harnesses included in the wire harness, and
the wire harness includes a second communication tube that brings inner portions of the first external tubes of two harnesses out of the plurality of harnesses into communication with each other.

3. The wire harness according to claim 1, comprising
a ventilation that is connected to the second external tube, and allows a passage of a gas therethrough, but restricts a passage of a liquid.

4. The wire harness according to claim 1,
wherein the first external tube, the second external tube, and the first communication tube are integrally formed.
